(19) United States
(12) Patent Application Publication
(10) Pub. No.: US 2018/0027604 A1
(43) Pub. Date: Jan. 25, 2018

(54) METHOD AND SYSTEM OF ASSIGNING WI-FI OR OTHER WIRELESS CHANNEL TO MOBILE APPLICATION

(71) Applicant: David Haag, Las Vegas, NV (US)

(72) Inventor: David Haag, Las Vegas, NV (US)

(21) Appl. No.: 15/655,775

(22) Filed: Jul. 20, 2017

Related U.S. Application Data
(60) Provisional application No. 62/364,785, filed on Jul. 20, 2016.

(51) Int. Cl. H04W 76/02; H04M 1/725; H04W 4/02

(52) U.S. Cl. CPC H04W 76/025; H04W 4/021; H04M 1/72544; H04M 1/72533; H04W 88/06

(57) ABSTRACT

The disclosed embodiments provide a method and system for connecting a mobile device to multiple other devices, allowing an application to use a specific wireless channel from a list of more than one wireless channel, and performing methods where a mobile device connects simultaneously to multiple other devices. In some embodiments, a mobile device operates with multiple Wi-Fi (wireless communication) networking devices, IoT devices, or other Wi-Fi enabled devices, and has multiple hardware Wi-Fi channels available. Each channel can be assigned to an executable application on the mobile device.

### CROSS-REFERENCE TO RELATED APPLICATION

This application claims priority to U.S. Provisional Application No. 62/364,785 which was filed on Jul. 20, 2016, the contents of which are hereby incorporated by reference.

### BACKGROUND

### 1. Field

The disclosed embodiments relate to networking devices. More specifically, the disclosed embodiments relate to mobile devices with multiple wireless channels and methods of using mobile devices with multiple wireless channels.

### 2. Related Art

Traditional mobile devices, or other devices that have a physical wireless communication channel, such as an “Internet of Things” (“IoT”) device, have a single channel that is used by any applications developed or running on the device. A typical mobile device, for example an Apple iPhone or an Android phone, has a shared single Wi-Fi, Bluetooth, or other wireless channel that any applications developed on the device must use to establish a wireless connection. With the proliferation of Wi-Fi connected devices, this presents a technical challenge of connecting to all the desired devices from a mobile device to run various applications on the mobile device.

Accordingly, methods and systems are needed to allow users to easily connect to multiple other devices and to perform tasks where the mobile device simultaneously connect to multiple other devices.

### SUMMARY

The disclosed embodiments provide a method and system for connecting a mobile device to multiple other devices, allowing an application to use a specific wireless channel from a list of more than one wireless channel, and performing methods where a mobile device connects simultaneously to multiple other devices. In some embodiments, a mobile device operates with multiple Wi-Fi (wireless communication) networking devices, IoT devices, or other Wi-Fi enabled devices, and has multiple hardware Wi-Fi channels available. Each channel can be assigned to an executable application on the mobile device.

Prior to having multiple wireless channels on a mobile device, applications were forced to make a connection to a single available channel. For example, if an application needed to use an external device using a Wi-Fi channel, the settings on the mobile device had to be changed in a settings menu to assign the Wi-Fi channel to that external device (e.g. a Wi-Fi router, or IoT device). This was a cumbersome operation. If another application needed to connect to a separate external device, the settings on the mobile device had to be changed again to assign the Wi-Fi channel to the other external device (e.g. a Sonos controller). This warrants unnecessary overhead by the operator of the device if an application needs to connect to a specific Wi-Fi device.

With multiple wireless channels, for example multiple Wi-Fi channels, a specific software application can be assigned to a wireless channel. Another application can be assigned to a second wireless channel. Other applications may be assigned to a different wireless channel. And the mobile device itself can have a community wireless channel that any applications can use when running.

In one embodiment, a casino floor or each gaming machine can implement a Wi-Fi connection point that is meant to be used by a specific mobile application. The mobile application connects to the casino floor Wi-Fi connection point through one of the Wi-Fi channels available on the mobile device. The mobile application communicates to the casino floor through the specified mobile channel while all other applications on the mobile device use one or more of the remaining mobile channels for wireless communication.

In another embodiment, two applications on a mobile device may need to execute at the same time where one application may be in the foreground and the other application is running in the background. For example, the foreground application may be an application that operates a drone or accesses the Internet while the background application is a music application that plays music from a cloud source. Both applications require a Wi-Fi connection with the background application requiring use of a generic Wi-Fi connection (connection A) and the foreground application requiring a specific Wi-Fi connection (connection B) to a Wi-Fi router built into the drone. This can only be accomplished with more than a single Wi-Fi channel or multiple radios on the mobile device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 illustrates an example embodiment of a mobile device.

FIG. 2 illustrates multiple Wi-Fi connections on a mobile device, according to an exemplary embodiment.

FIG. 3 shows a method of connecting to a network and a remote device simultaneously, according to one exemplary embodiment.

FIG. 4 shows a method of using simultaneous dedicated connections, according to an exemplary embodiment.

FIG. 5 shows a method of sending control instructions to a remote device using simultaneous connections, according to an exemplary embodiment.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

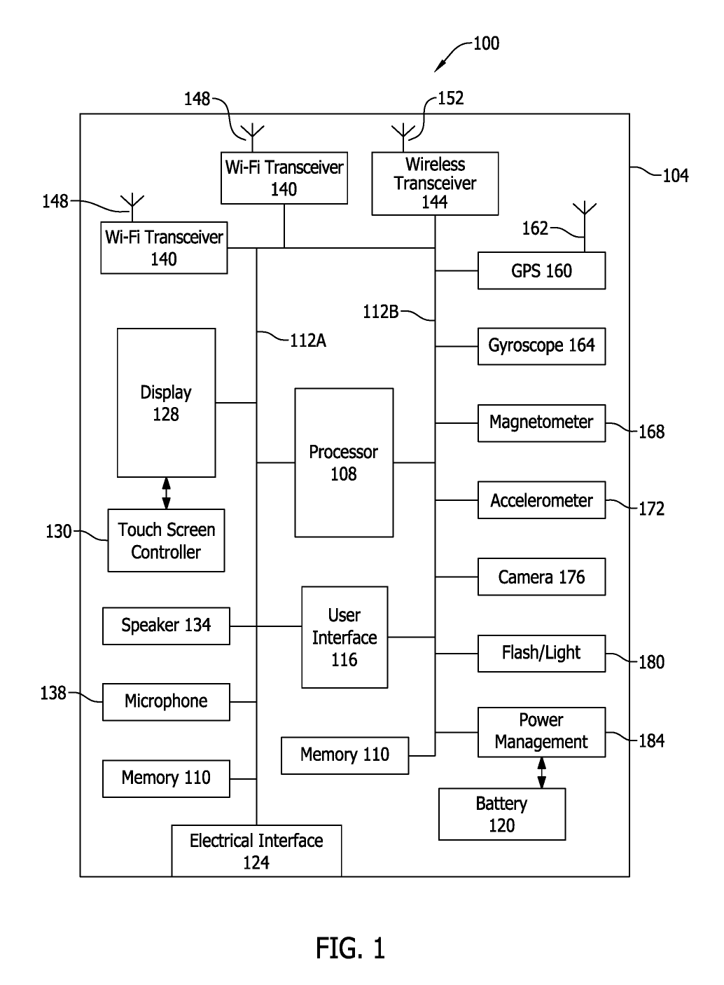

FIG. 1 illustrates an example embodiment of a mobile device. This is but one possible mobile device configuration and as such it is contemplated that one of ordinary skill in the art may differently configure the mobile device. The mobile device 100 may comprise any type of mobile communication device capable of performing as described below. The mobile device may comprise a PDA, cellular telephone, smart phone, tablet PC, wireless electronic pad, an IoT device, a “wearable” electronic device, or any other computing device.

In this example embodiment, the mobile device 100 is configured with an outer housing 104 configured to protect and contain the components described below. Within the housing 104 is a processor 108 and a first and second bus 112A, 112B (collectively 112). The processor 108 communicates over the buses 112 with the other components of the mobile device 100. The processor 108 may comprise any type processor or controller capable of performing as described herein. The processor 108 may comprise a general-purpose processor, ASIC, ARM, DSP, controller, or any other type of processing device. The processor 108 and other elements of the mobile device 100 receive power from a battery 120 or other power source. An electrical interface 124 provides one or more electrical ports to electrically interface with the mobile device, such as with a second electronic device, computer, a medical device, or a power supply/charging device. The interface 124 may comprise any type electrical interface or connector format.

One or more memories 110 are part of the mobile device 100 for storage of machine readable code for execution on the processor 108 and for storage of data, such as image data, audio data, user data, medical data, location data, accelerometer data, or any other type of data. The memory 110 may comprise RAM, ROM, flash memory, optical memory, or micro-drive memory. The machine-readable code as described herein is non-transitory.

As part of this embodiment, the processor 108 connects to a user interface 116. The user interface 116 may comprise any system or device configured to accept user input to control the mobile device 100. The user interface 116 may comprise one or more of the following: keyboard, roller ball, buttons, wheels, pointer key, touch pad, and touch screen. A touch screen controller 130 is also provided which interfaces through the bus 112 and connects to a display 128.

The display 128 comprises any type display screen configured to display visual information to the user. The screen may comprise a LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 128 receives signals from the processor 108 and these signals are translated by the display 128 into text and images as is understood in the art. The display 128 may further comprise a display processor (not shown) or controller that interfaces with the processor 108. The touch screen controller 130 may comprise a module configured to receive signals from a touch screen which is overlaid on the display 128.

Also part of this exemplary mobile device is a speaker 134 and microphone 138. The speaker 134 and microphone 138 may be controlled by the processor 108. The microphone 138 is configured to receive and convert audio signals to electrical signals based on processor 108 control. Likewise, the processor 108 may activate the speaker 134 to generate audio signals. These devices operate as is understood in the art and as such are not described in detail herein.

Also connected to one or more of the buses 112 is two or more Wi-Fi transceivers 140 with respective antennas 148. One or more additional wireless transceivers 144 are also provided with respective antennas 152. The transceivers 140, 144 are configured to receive incoming signals from a remote transmitter and perform analog front-end processing on the signals to generate analog baseband signals. The incoming signal maybe further processed by conversion to a digital format, such as by an analog to digital converter, for subsequent processing by the processor 108. Likewise, the transceivers 140, 144 are configured to receive outgoing signals from the processor 108, or another component of the mobile device 108, and up convert these signal from baseband to RF frequency for transmission over the respective antenna 148, 152.

It is contemplated that the mobile device 100, and hence the Wi-Fi transceivers 140 and additional wireless transceiver 144 may be configured to operate according to any presently existing or future developed wireless standard. For example, the Wi-Fi transceiver may operate according standards including, but not limited to Wi-Fi such as IEEE 802.11 a, b, g, n, ac wireless LAN. The wireless transceiver may operate according to standards including, but not limited to, Bluetooth, NFC, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the mobile device is one or more systems connected to the second bus 112B which also interface with the processor 108. These devices include a global positioning system (GPS) module 160 with associated antenna 162. The GPS module 160 is capable of receiving and processing signals from satellites or other transponders to generate location data regarding the location, direction of travel, and speed of the GPS module 160. GPS is generally understood in the art and hence not described in detail herein. A gyroscope 164 connects to the bus 112B to generate and provide orientation data regarding the orientation of the mobile device 104. A magnetometer 168 is provided to provide directional information to the mobile device 104. An accelerometer 172 connects to the bus 112B to provide information or data regarding shocks or forces experienced by the mobile device.

One or more cameras (still, video, or both) 176 are provided to capture image data for storage in the memory 110 and/or for possible transmission over a wireless or wired link or for viewing at a later time. The one or more cameras 176 may be configured to detect an image using visible light and/or near-infrared light. The cameras 176 may also be configured to utilize image intensification, active illumination, or thermal vision to obtain images in dark environments.

A flasher and/or flashlight 180, such as an LED light, are provided and are processor controllable. The flasher or flashlight 180 may serve as a strobe or traditional flashlight. The flasher or flashlight 180 may also be configured to emit near-infrared light. A power management module 184 interfaces with or monitors the battery 120 to manage power consumption, control battery charging, and provide supply voltages to the various devices which may require different power requirements.

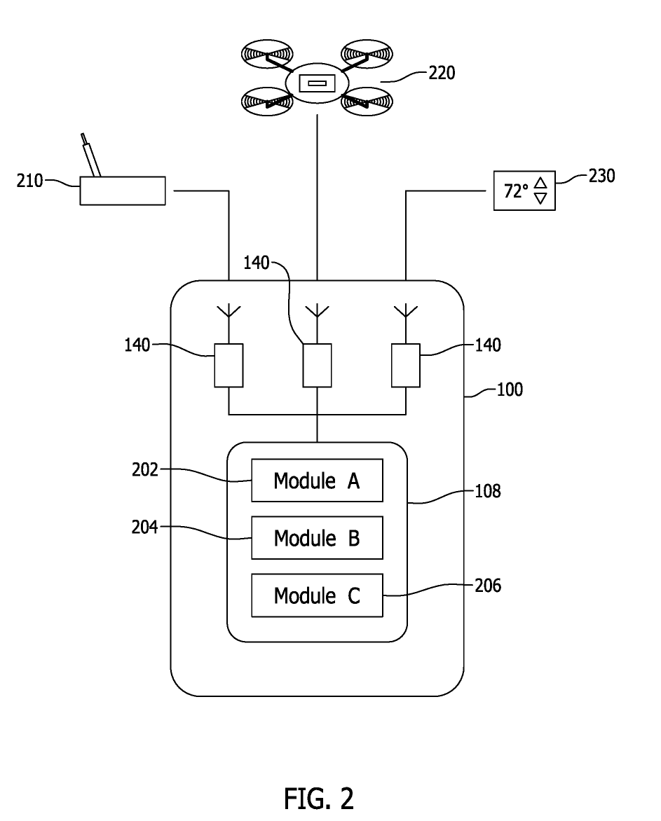

FIG. 2 illustrates multiple Wi-Fi connections on a mobile device, according to an exemplary embodiment. In FIG. 2, the mobile device 100 is shown to have three Wi-Fi transceivers 140. This allows the mobile device 100 to connect simultaneously with several Wi-Fi enabled remote devices. In this example, the mobile device 100 is simultaneously connected to a router 210 to access a network or other device connected to the router, a drone 220 that is operated via a Wi-Fi connection with the mobile device 100, and an internet connected thermostat 230.

In some embodiments, software modules or applications running on the processor 108 may control the connection and/or data transmitted over the connection for each of the Wi-Fi transceivers 140. In this example, a module A 202 may control the connection to the router 210, module B 204 may control the connection to the drone 220, and module C may control the connection to the thermostat 230.

Stated more generally, the plurality of Wi-Fi transceivers allow the mobile device to connect to several Wi-Fi dedicated devices simultaneously to allow for multi-tasking or other new functionality of the mobile device. Such Wi-Fi devices may include devices controlled directly via a Wi-Fi connection such as the drone 220 controlled via the mobile device 100. Typically, a user of a mobile device 100 would be required to disconnect from a network (such as from the router 210) to connect to the drone 220 to control the drone. With the configuration described herein, the mobile device 100 may maintain a connection with the network while controlling the drone 220. This may facilitate a more user-friendly experience because the user does not need to change any Wi-Fi settings on the mobile device 100 to connect to the drone 220. Other operations such as firmware updates for the drone 220 may easily be facilitated through the mobile device 100 connected to both a network and the drone 220.

The configuration may also aid in a more user-friendly adoption of Internet of Things (IoT) devices. Typically, to set up an IoT device, a user must transfer network information to the IoT device so that the IoT device can access the network. This requires the user to disconnect from the network to connect the mobile device's Wi-Fi to the IoT device in order to set up the IoT device. Such a process may be difficult for a person who is not confident using technology. However, with the present configuration, the user may simply connect to the IoT device without the need to disconnect from a network. This may even be controlled by an application to easily set up an IoT device on a network.

Other types of functionality using multiple Wi-Fi connections is facilitated. For example, simultaneous connections to public and secure networks, peer to peer networks, and other various connections may be achieved.

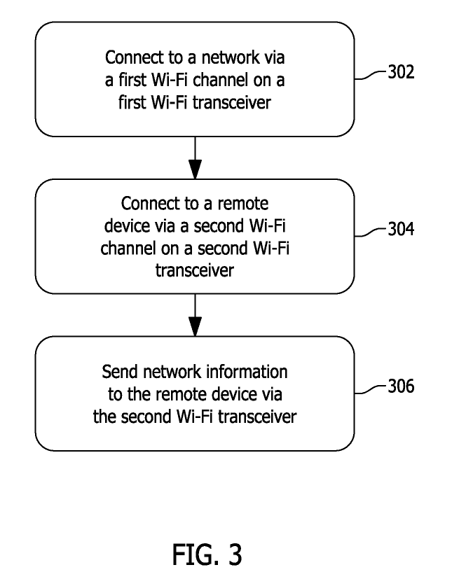

Examples of methods facilitated through the above-described configurations will be described with reference to FIGS. 3-5. These methods are not an exhaustive list of novel methods, and the methods may be modified and adapted for various applications.

FIG. 3 shows a method of connecting to a network and a remote device simultaneously, according to one exemplary embodiment. In step 302, a mobile device connects to a network via a first Wi-Fi channel with a first Wi-Fi transceiver. For example, mobile device 100 may connect to a router 210 to gain access to a network. While connected to the network, the mobile device connects to a remote device via a second Wi-Fi channel on a second Wi-Fi transceiver. By utilizing the multiple transceivers, the mobile device 100, for example, connects to both the router 210 and smart thermostat 230 simultaneously. As a result, in step 306, the mobile device may send network information to the remote device via the second Wi-Fi transceiver.

The method above may provide several advantages. For example, when setting up an IoT device, such as the smart thermostat 230, the smart thermostat 230 needs to be provided with network access information to connect to the Internet via the network. In order to do this, the mobile device 100 must connect to the thermostat using a Wi-Fi connection. With the above-described method, the mobile device 100 simply uses the second transceiver to connect to the thermostat 210 to provide network information to the thermostat 210. This makes the process simple and intuitive for the user because the user does not need to disconnect from the network (e.g. router 210) to begin the process.

Other benefits are also possible. For example, the mobile device 100 may deliver firmware updates to the remote device through the simultaneous connection. The mobile device 100 may also serve as a Wi-Fi signal extender to increase the range of the router 210 to other remote devices. The remote device may also be second router connecting the mobile device to a second network. Additionally, the remote device may be another mobile device or other computing device allowing the mobile device to be connected to a router and to a peer-to-peer network simultaneously.

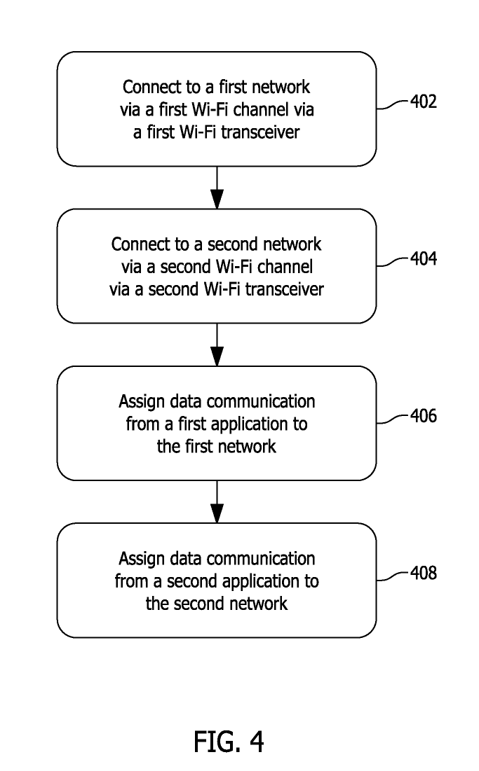

FIG. 4 shows a method of using simultaneous dedicated connections, according to an exemplary embodiment. In step 402, the mobile device connects to a first network via a first Wi-Fi channel with a first Wi-Fi transceiver. In step 404, the mobile device connects to a second network via a second Wi-Fi channel using a second Wi-Fi transceiver.

As an example, an establishment such as a casino, an amusement park, or other resort, may have different networks available for different purposes. A public Wi-Fi may be provided that allows access to the Internet for visitors of the establishment. Other networks may also be provided so serve specific purposes and may have additional security measures such as encryption, geofencing, password protection, and the like. For example, a casino may provide a secure network in a gaming area of the casino that allows wagers to made via the mobile devices on game outcomes being played or observed in the gaming area. Such a network may be encrypted and may require the mobile device to be within a certain distance of the gaming area. For security, such a network may not be connected to the Internet.

In step 406 of FIG. 4, the mobile device assigns data communication from a first application to the first network, and in step 408, the mobile device assigns data communication from a second application to the second network.

In the above example, the mobile device 100 may control communication from software module A 202 to be dedicated to the first network, and communication from software module B 204 to be dedicated to the second network. Software module A 202, for example, may be an Internet browser and the processor 108 dedicates the data communication from the browser through the first network, which may be a public Wi-Fi network for accessing the Internet. Software module B may be gaming software provided by a casino. The processor 108 may run the gaming software such that data communication for the gaming software is through the second network. This allows a visitor of a casino, for example, to access email and websites via general public Wi-Fi while simultaneously connecting to a secured gaming network or to a specific casino gaming device for placing bets or playing a game in a gaming area of a casino.

Other functionality that is carried out on designated networks may be executed by the above method. The above method may allow a specific application to automatically connect to the second network without a user accessing Wi-Fi settings on his/her mobile device. Such other designated networks that may utilize the method include accounting networks, employee networks, game networks, etc.

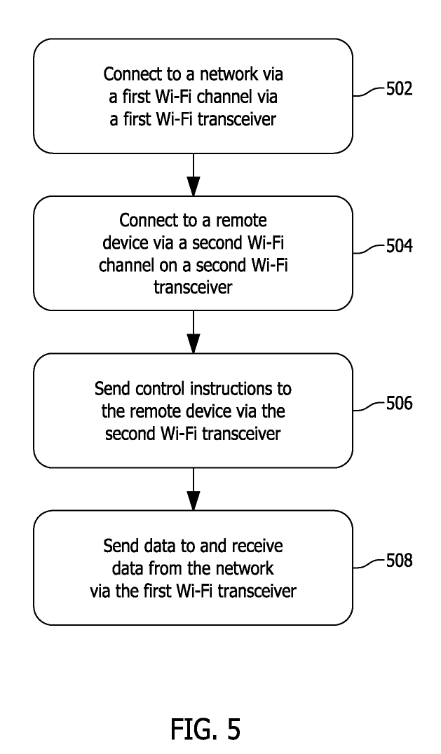

FIG. 5 shows a method of sending control instructions to a remote device using simultaneous connections, according to an exemplary embodiment. In step 502, a mobile device connects to a network via a first Wi-Fi channel through a first Wi-Fi transceiver. In step 504, the mobile device connects to a remote device via a second Wi-Fi channel on a second Wi-Fi transceiver.

In one example, the mobile device 100 connects via a router 210 to a network, and then simultaneously connects to a dedicated Wi-Fi device such as a drone 220. This allows the user to simply and easily connect to the drone 220 without accessing Wi-Fi settings in the mobile device 100 to disconnect from the network.

In step 506, the mobile device sends control instructions to the remote device via the second Wi-Fi transceiver. The mobile device may also receive data from the remote device via the second Wi-Fi transceiver. The mobile device also sends and receives data from the network via the first Wi-Fi transceiver.

For example, the user may access an application from a mobile device 100 that controls a drone 220 and/or receives a video feed from a drone 220. The application may control a connection to the drone 220 without disconnecting the mobile device 100 from a network, such as to a connection to router 210. This allows the mobile device to send and receive information over the network and to and from the drone 220 simultaneously. An application controlling the drone 220 may also update drone firmware via the connection from the mobile device 100 to the network.

Other features are also possible. In one embodiment, an application with a user interface is provided to manage the two or more Wi-Fi connections to the various devices. The application may assign processor cores of the processor of the mobile devices to control data communication for each of the Wi-Fi transceivers. The application may also manage power consumption of each of the connections to prevent battery loss on the mobile device.

A user may use the application to create connection rules for each saved device. Such rules may be based on geolocation, time, or software accessed at the mobile device. The application may provide reports for data speed, security, and activity history for each of the connections via the Wi-Fi transceivers.

In the above description, reference is made throughout to a mobile device, such as a smart phone or tablet computing device. However, other Wi-Fi connected devices may operate similarly such as a laptop or desktop computer, a kiosk, a casino gaming machine, or the like. Additionally, the above description outlines systems and methods for utilizing multiple Wi-Fi transceivers in a mobile device. The description may also be applied to using multiple transceivers of other wireless protocols, such as Bluetooth, LTE, WiMAX, etc.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A mobile device comprising:
at least one input device;
a display;
a first and a second wireless transceiver having a first wireless communication protocol;
a processor; and
a memory storing machine-readable instructions executable on the processor to cause the mobile device to:
connect to a first network via a first wireless channel on the first wireless transceiver;
simultaneously connect to a remote device via a second wireless channel on the second wireless transceiver; and
transmit information regarding the first network to the remote device via the second wireless transceiver.

2. The mobile device of claim 1, wherein the remote device is an Internet of Things device, and the network information is network access information.

3. The mobile device of claim 1, wherein the first wireless communication protocol is a Wi-Fi protocol.

4. A method of controlling simultaneous connections on a mobile device comprising at least one input device, a display, a first and a second wireless transceiver having a first wireless communication protocol, a processor, and a memory storing machine-readable instruction executable on the processor, the method comprising:
connecting the mobile device to a first network via a first wireless channel via the first wireless transceiver;
simultaneously connecting the mobile device to a second network via a second wireless channel via the second wireless transceiver;
assigning via the processor data communication from a first application running on the mobile device to the first network; and
assigning via the processor data communication from a second application running on the mobile device to the second network.

5. The method of claim 4, wherein the first network connects to the internet.

6. The method of claim 5, wherein the second network is a secured network.

7. The method of claim 6, wherein the secured network is a gaming network at a gaming establishment, the second application is a gaming application facilitating wagering and/or game play at the mobile device.

8. The method of claim 7, wherein the gaming network connects the mobile device to a gaming machine.

9. The method of claim 7, wherein the second application limits access to the secured network based on geographic location of the mobile device.

10. A mobile device comprising:
at least one input device;
a display;
a first and a second wireless transceiver having a first wireless communication protocol;
a processor; and
a memory storing machine-readable instructions executable on the processor to cause the mobile device to:
connect to a first network via a first wireless channel on the first wireless transceiver;
simultaneously connect to a remote device via a second wireless channel on the second wireless transceiver; and
send control instructions to the remote device via the second wireless transceiver.

11. The mobile device of claim 10, wherein the remote device is a drone and the control instructions comprise movement directions.

12. The mobile device of claim 11, wherein the mobile device receives data from the drone via the second wireless transceiver.

13. The mobile device of claim 10, wherein the mobile device sends data and receives data from the network via the first wireless transceiver.

14. The mobile device of claim 13, wherein the mobile device updates firmware of the remote device.
